(19) United States
(12) Patent Application Publication
(10) Pub. No.: US 2012/0325733 A1
(43) Pub. Date: Dec. 27, 2012

(54) Reverse osmosis and de-ionized water supply for window cleaning

(76) Inventor: Meyer Ostrobrod, Philadelphia, PA (US)

(21) Appl. No.: 13/135,036

(22) Filed: Jun. 23, 2011

(51) Int. Cl. B01D 35/02; B01D 36/00; C02F 1/44

(52) U.S. Cl. 210/241

(57) ABSTRACT

A water filtering system for supplying filtered water for washing the windows or other surfaces of a building includes a cart having a frame and a plurality of wheels for allowing the cart to be easily moved around. A plurality of filters for filtering water are mounted on the cart and including an inlet that is adapted to connected to a conventional spigot supplying water from a public or private water system. The plurality of filters includes a reverse osmosis unit having a membrane therein. The reverse osmosis unit has a first outlet for clean water that has entered the unit and has passed through the membrane and a second outlet for dirty water that has entered the unit but has not passed through the membrane. A hose is connected to the first outlet for supplying clean water to a spray nozzle for cleaning the windows. Additional filters such as a de-ionization unit, a sediment filter and a charcoal filter can be used in front of the reverse osmosis unit to further purify the water. A collection pan located beneath the reverse osmosis unit captures the dirty water from the second outlet. A second hose and a pump carried by the cart utilize the dirty water to prewash the window before being cleaned by the clean water.

### BACKGROUND OF THE INVENTION

The present invention is directed toward a water supply washing or cleaning system and more particularly toward a washing or cleaning system that utilizes filtered and de-ionized water for cleaning windows and a variety of other surfaces on the exterior of a building and which captures and reuses the dirty water created by the reverse osmosis filtering and de-ionizing apparatus of the invention.

Products for cleaning hard surfaces are widely available on the market. These products are used for two purposes, the first being to clean soil from the surface and the second being to leave the surface with an aesthetically pleasing finish, e.g. spot-free or shiny. However, products available on the market often require rinsing with water after use. Typically when the water dries from the surface water-marks, smears, streaks, or spots are left behind.

These water-marks are due to the evaporation of water from the surface leaving behind deposits of minerals which were present as dissolved solids in the water, for example calcium, magnesium and sodium ions and salts thereof or may be deposits of water-carried soils. This problem is particularly apparent when cleaning ceramic, steel, plastic, glass or painted surfaces. A means of solving this problem, known in the art is to dry the water from the surface using a squeegee or cloth or chamois before the water-marks form. However, this drying process is time consuming and requires considerable physical effort. In many cases, due for example to the height of the windows being washed, manual drying is not possible.

Systems have been proposed in the past to address this problem. For example, PCT Publication WO 97/48927 is directed to a cleaning composition, method, and apparatus for cleaning exterior windows. This publication allegedly discloses a no scrub/no wipe method for cleaning exterior windows without filming or spotting. A spray gun comprising separate chambers for a cleaning composition and an ion exchange resin is disclosed. The method involves spraying a cleaning composition on the window surface, preparing purified rinse water by passing the rinse water through the ion exchange resin and rinsing the window surface with the purified rinse water. While the use of this spray gun may initially solve the problem of residual water marks on surfaces on drying, the spray guns have an inefficiently short life-span that requires the user to replace the ion-exchange resin cartridge after each use.

PCT Publication WO 98/01223 is directed to a portable hand held device for converting tap water into a spray of de-ionized water. This publication states that it discloses a device for producing a controlled spray of de-ionized water, useful for rinsing cars and windows. This publication further states that the prior art has failed to provide teachings of a lightweight and readily portable, economical device and method for “real time” conversion of tap water into de-ionized water which can be used to, among other things, rinse surfaces after cleaning without leaving water spots if the surface is not wiped dry.

While spray guns and other hand held devices, such as the above examples, are portable, there are some problems. For example, hand held devices are inherently limited in size, weight, and bulkiness to accommodate their hand held use. Thus, hand held units usually have an ion exchange resin cartridge inside the spray gun. This limits the size of the ion exchange resin cartridge, and consequently the life span of the ion exchange resin cartridge is short, and may require more frequent changes. In addition, a person washing a building or large surface may want to soak or brush the surface or bring the pressurized water closer to the surface without mounting a ladder or other type of extension. A spray gun is not optimum in these instances.

U.S. Pat. No. 7,874,757 to Bruggeman attempts to improve upon these spray gun systems. The Bruggeman connects to a water source and uses a portable cylindrical de-ionized water unit, a garden hose, a replaceable ion exchange resin cartridge, a brush pole system, and a second hose. The cylindrical de-ionized water unit includes a valve that allows either water directly from the garden hose to be sprayed or water that has passed through the de-ionization unit to be used. Because of the size of the de-ionization unit, it may last longer than prior smaller spray guns.

While de-ionized water is known to clean windows and similar surfaces, it is also known that it is desirable to first filter the water through other types of filters as this improves the de-ionization process. It is particularly beneficial to first filter the water utilizing reverse osmosis. Through the use of a membrane, reverse osmosis provides hyper filtration, removing almost all contaminants. Unfortunately, reverse osmosis treatments require an enormous amount of water. Such systems typically return as “clean” water as little as 5 to 15 percent of the water pushed through the system membrane. What's left then exits the system as wastewater or “dirty” water.

Thus, when washing windows or other building surfaces, very large amounts of dirty water would be wasted. Simply utilizing reverse osmosis units in a window washing system would be a waste of enormous amounts of water which would make such a system more expensive to operate and economically and environmentally undesirable.

Therefore, a need exists for a window washing system that utilizes the benefits of de-ionization and reverse osmosis but which does not waste water produced thereby.

### SUMMARY OF THE INVENTION

The present invention is designed to overcome the deficiencies of the prior art discussed above. Accordingly, it is an object of the invention to provide a window washing system that is effective in cleaning windows and easy to use.

It is a further object of the present invention to provide a window washing system that is easily movable from place to place.

It is a still further object of the invention to provide a window washing system that includes the benefits of de-ionization and reverse osmosis but which does not waste water.

In accordance with the illustrative embodiments demonstrating features and advantages of the present invention, there is provided a water filtering system for supplying filtered water for washing the windows or other surfaces of a building that includes a cart having a frame and a plurality of wheels for allowing the cart to be easily moved around. A plurality of filters for filtering water are mounted on the cart and including an inlet that is adapted to connected to a conventional spigot supplying water from a public or private water source. The plurality of filters includes a reverse osmosis unit having a membrane therein. The reverse osmosis unit has a first outlet for clean water that has entered the unit and has passed through the membrane and a second outlet for dirty water that has entered the unit but has not passed through the membrane. A hose is connected to the first outlet for supplying clean water to a spray nozzle for cleaning the windows. Additional filters such as a de-ionization unit, a sediment filter and a charcoal filter can be used in front of the reverse osmosis unit to further purify the water. A collection pan located beneath the reverse osmosis unit captures the dirty water from the second outlet. A second hose and a pump carried by the cart utilize the dirty water to prewash the window before being cleaned by the clean water.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a perspective view shown somewhat schematically of the reverse osmosis and de-ionized water supply for window cleaning of the present invention;

FIG. 2 is a view of the invention similar to FIG. 1 with portions removed for clarity;

FIG. 3 is a top plan view showing the pan for collecting dirty water from the reverse osmosis unit;

FIG. 4 is a perspective view of the forward end of the pan showing the hose connections thereto, and

FIG. 5 is a schematic representation showing the interconnections of the operative components of the invention.

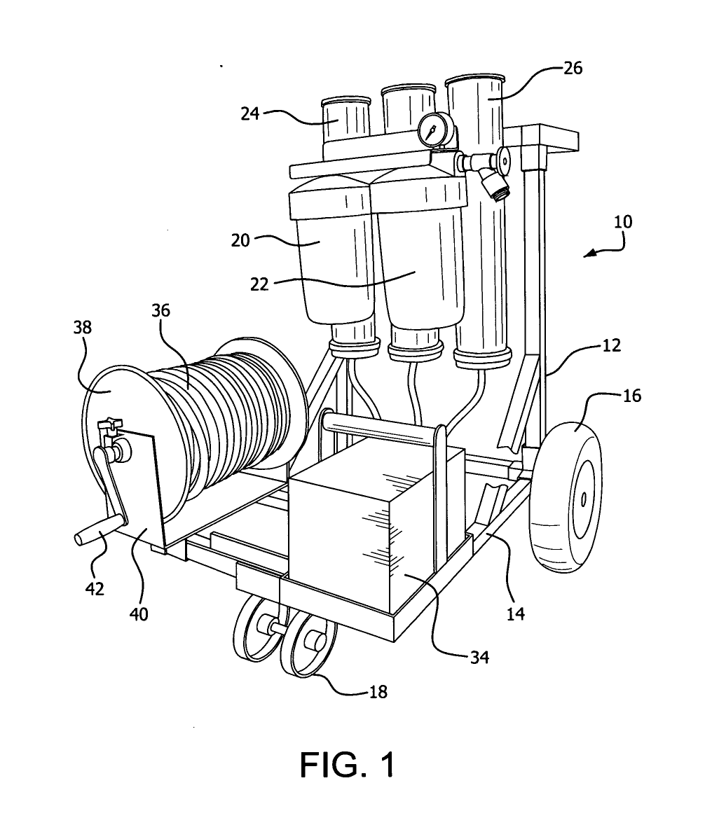

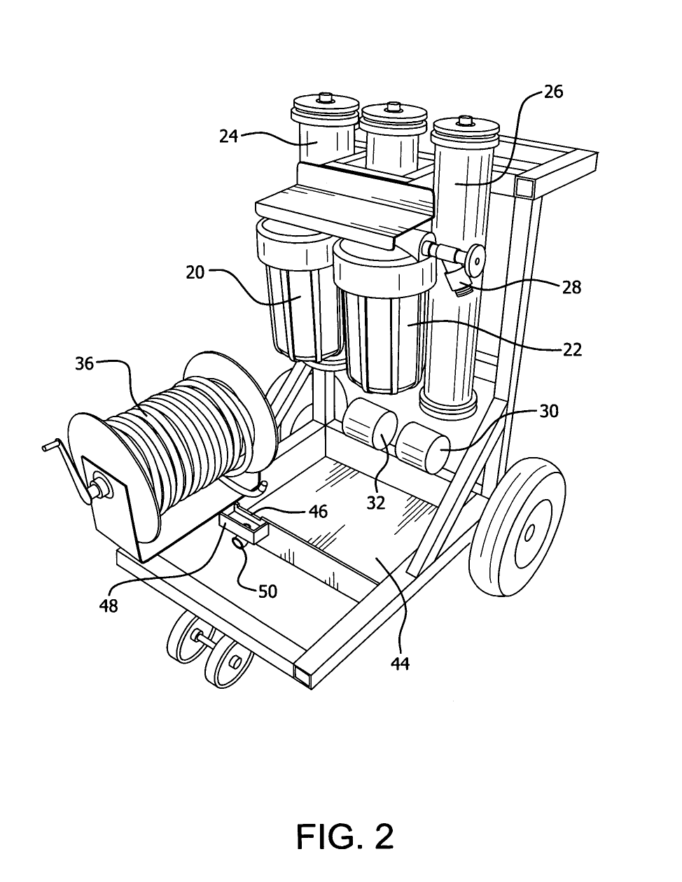

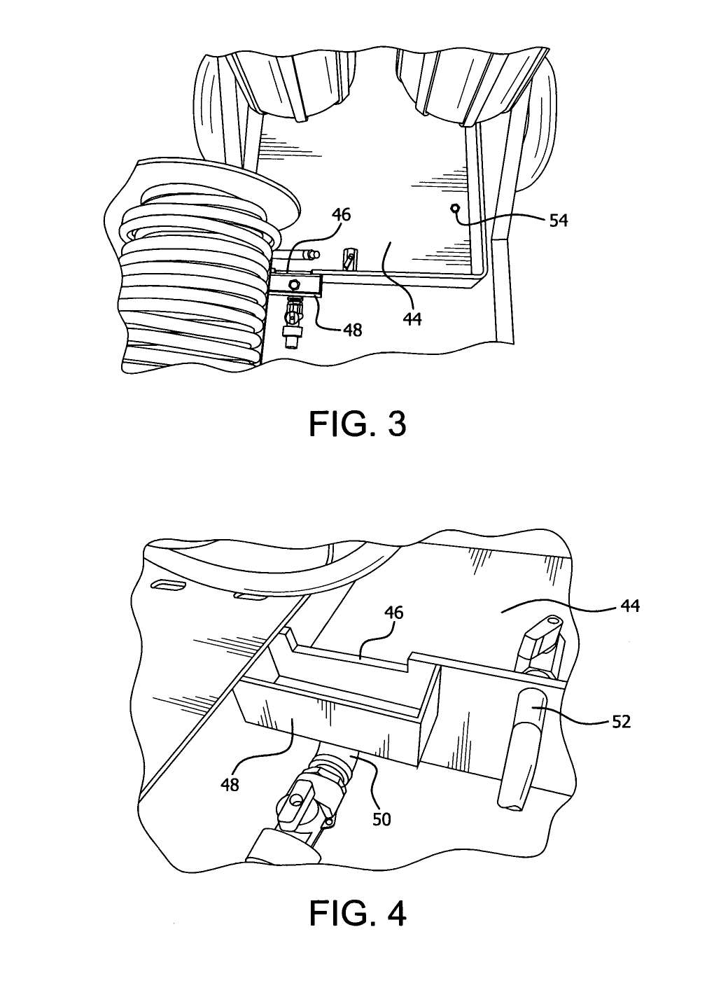

### DETAILED DESCRIPTION OF THE PREFERRED EMBODIMENT

Referring now to the drawings in detail wherein like reference numerals have been used throughout the various figures to designate like elements, there is shown in the figures a reverse osmosis and de-ionized water supply for window cleaning constructed in accordance with the principles of the present invention and designated generally as 10. The system 10 is comprised essentially of a cart 12 including a frame 14 and a plurality of wheels 16 and 18 for allowing the cart to be easily moved around from location to location.

A plurality of filtering means such as shown at 20, 22, 24 and 26 are mounted on the cart frame 14 and include an inlet such as shown at 28 which is adapted to be connected to a source of water such as from a conventional public or private water system. The filtering means will be described in more detail below.

Also carried by the cart 12 are one or more electrically operated pumps 30 and 32 which are powered by a storage battery 34. Appropriate electrical circuitry well known in the art will, of course, also be provided for interconnecting the pumps and the battery and will include appropriate switches, controls, gauges and the like.

One or more hoses such as shown at 36 will also be carried by the cart 12. The hose 36 is wound on a reel 38 which is supported for rotational movement by the reel support 40 mounted on the cart frame 14. A crank handle 42 can be used to wind the hose 36.

As will be explained more fully hereinafter, the hose 36 can be connected to either clean water produced by the filtering system of the invention or dirty water. Alternatively, two separate hoses can be provided with one being connected to the dirty water and the other to the clean water. In either case, the hoses such as hose 36 is adapted to be connected to a window washing spray nozzle or broom and can be through an extension pole such as described in U.S. Pat. No. 7,416,361, the entire disclosure thereof being incorporated herein by reference.

The dirty or waste water from the reverse osmosis unit that will be described in more detail hereinafter can either be connected to a hose directly or through a pump or can be allowed to drain into the pan 44 carried by the cart frame 14 and located beneath the filters. The front wall of the pan 44 includes a reduced or lowered portion 46 which allows water from the pan to flow over into the cup 48 attached thereto. This provides two functions. First, it insures that sediment will not flow into the cup 48 since it will settle at the bottom of the pan 44. It also provides a means for draining overflow from the pan 44 into another storage tank for use at a later time. Thus, dirty water from the pan 44 can be removed therefrom either through the coupling 50 connected to the cup 48 or through the coupling 52 also connected to the front wall of the pan 44. If it is ever desired to totally drain the pan 44, a drain hole 54 is provided in the bottom wall thereof.

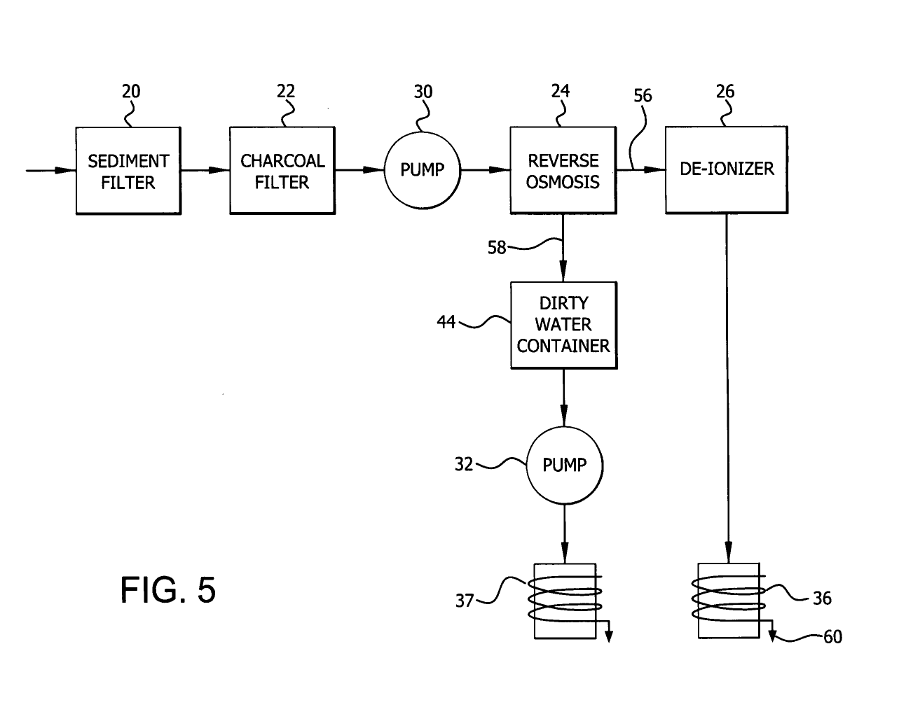

The operation of the reverse osmosis and de-ionized water supply system of the present invention is best understood from viewing FIG. 5 which is a schematic representation of the system. Source water from a standard spigot or faucet from a water source is first fed through sediment filter 20. The output of the sediment filter 20 is then fed into and through the charcoal filter 22. Thereafter, and with the aid of pump 30, the filtered water passes into the reverse osmosis unit 24.

As is well known in the art, the reverse osmosis unit 24 includes a membrane therein which removes substantially all contaminants from the water. As is also well known in the art, however, reverse osmosis units typically return as “clean” water as little as 5 to 15 percent of the water that is pushed through the system membrane. What is left then exits the reverse osmosis unit as waste water or “dirty” water. There are, therefore, two outlets from the reverse osmosis unit. The first outlet 56 is connected to the de-ionizer 26 and from there to hose 36 for supplying clean water to spray nozzle 60 for cleaning windows or the building surfaces.

The second output 58 from the reverse osmosis unit 24 can either be connected directly to hose 37 through the pump 32 or can drain into the dirty water container or pan 44. From there, pump 32 can supply the dirty water to the hose 37 for use in preliminarily cleaning windows or other building surfaces.

When utilizing the system of the present invention, two workers can simultaneously clean windows. The first worked, utilizing the dirty water and hose 37, prewashes the windows or other surface to remove the major dirt therefrom. The second worker, utilizing the second hose 36, follows with the clean water. Alternatively, a single worker can first prewash the windows with hose 37 and then follow up with the final cleaning utilizing hose 36.

The present invention may be embodied in other specific forms without departing from the spirit or essential attributes thereof and accordingly, reference should be made to the appended claims rather than to the foregoing specification as indicating the scope of the invention.

I claim:

1. A water filtering system for supplying filtered water for washing the windows or other surfaces of a building comprising:
a cart including a frame and a plurality of wheels for allowing said cart to be easily moved around;
a plurality of filtering means for filtering water, said plurality of filtering means being mounted on said cart frame and including an inlet;
means for connecting the inlet of said plurality of filtering means to a water supply;
said plurality of filtering means including a reverse osmosis unit having a membrane therein, said reverse osmosis unit having a first outlet for clean water that has entered said unit and has passed through said membrane and a second outlet for dirty water that has entered said unit but has not passed through said membrane;
a hose means adapted to be connected to said first outlet for supplying clean water to a spray nozzle for cleaning said window or other building surfaces, and
means carried by said cart for collecting said dirty water from said second outlet of said reverse osmosis unit.

2. The water filtering system for supplying filtered water for washing the windows or other surfaces of a building claimed in claim 1 wherein said plurality of filtering means includes a de-ionization unit.

3. The water filtering system for supplying filtered water for washing the windows or other surfaces of a building claimed in claim 1 wherein said plurality of filtering means includes a sediment filter.

4. The water filtering system for supplying filtered water for washing the windows or other surfaces of a building claimed in claim 1 wherein said plurality of filtering means includes a charcoal filter.

5. The water filtering system for supplying filtered water for washing the windows or other surfaces of a building claimed in claim 1 including a second hose means for directing said dirty water toward said windows or other building surfaces prior to the application thereof of said clean water.

6. The water filtering system for supplying filtered water for washing the windows or other surfaces of a building claimed in claim 1 wherein said means carried by said cart for collecting said dirty water from said second outlet of said reverse osmosis unit includes a collection pan located beneath said reverse osmosis unit.

7. The water filtering system for supplying filtered water for washing the windows or other surfaces of a building claimed in claim 6 wherein said pan includes an outlet adapted to be connected to said second hose means.

8. The water filtering system for supplying filtered water for washing the windows or other surfaces of a building claimed in claim 7 wherein said second hose means includes a pump.

9. The water filtering system for supplying filtered water for washing the windows or other surfaces of a building claimed in claim 8 further including a battery carried by said cart for powering said pump.
